(19) United States
(12) Patent Application Publication
(10) Pub. No.: US 2008/0135477 A1
(43) Pub. Date: Jun. 12, 2008

(54) Premium Quality All Natural Sea Salt Production Process

(76) Inventor: Clayton Allan Lank, Welshpool (CA)

Correspondence Address: Clayton A. Lank;L&C Enterprises / Quoddy Mist, 72 Water Street, Lubec, ME, 04652, US

(21) Appl. No.: 11/567,771

(22) Filed: Dec. 7, 2006

(51) Int. Cl. C02F 1/58

(52) U.S. Cl. 210/638

(57) ABSTRACT

The invention discloses a four phase environmentally controlled process to obtain premium food quality all natural sea salt crystals of various size and/or shape without losing the trace minerals naturally present in the sea water. Pre-determined set points which are used to determine the quality(ies)/sizes and shapes of the sea salt crystals to be produced are established by the operator at the master control panel for: (1) maximum temperature for the energy source, (2) the temperature of the brine within the evaporator, and (3) the required specific gravity of the brine just prior to brine release to the tables. The placement of the specific gravity sensor automates flow of the brine to the tables for crystal formation. The entire process allows production of a variety of premium quality all natural sea salt crystal shapes and sizes on a year round basis.

### BACKGROUND OF THE INVENTION

1. Field of the Invention

This invention is a process for evaporating sea water to obtain natural salt crystals in a variety of shapes and sizes without losing the trace minerals naturally present in the sea water.

2. Description of Related Art

The salt creation method makes a real difference. Near the coast of Northwestern France, the ocean water is rich in a variety of minerals. In the process used there, the sea water is channeled into clay ponds where the sun and wind evaporate the water leaving a lightly colored (derived from the mineral rich clay) mineral rich salt. Other sea salts have been washed, boiled, and also dried at high temperature which removes minerals and trace elements. Everyday table salt is pure white, but it has been washed, boiled, dried at high heat, and mixed with iodine, bleach and anti-caking agents. All natural sea salts have better flavor due to their unique combinations of trace elements and minerals; consequently, consumers actually use less sea salt than highly processed table salt (97% sodium chloride). The all natural sea salt produced by this invention (process) is sparkling white and clean, and consists of naturally lower percentages of sodium chloride and higher percentages of trace minerals and elements.

We employed the following keyword search strategies:
1. “sea water” and minerals and evaporate
2. “sea water” and “specific gravity”
3. “sea water” and evaporate and process
4. “sea salt” and evaporate and process
5. “sea salt” and “specific gravity”
6. “sea salt” and “minerals and evaporate

The following references were reviewed:

U.S. Patents:
U.S. Pat. No. 7,008,516
U.S. Pat. No. 6,890,509
U.S. Pat. No. 6,776,972
U.S. Pat. No. 6,500,216
U.S. Pat. No. 5,814,224
U.S. Pat. No. 5,487,423
U.S. Pat. No. 4,334,886
U.S. Pat. No. 3,147,072
U.S. Pat. No. 1,873,329
U.S. Pat. No. 1,305,566
U.S. Pat. No. 1,304,097

European Patents (abstracts only)
European Patent No. BG49202
European Patent No. CN1048685
European Patent No. DE19940992

Internet References:
“Brine Evaporators and Salt Production” available at http://www/uyseg.org/industryanimnated/teachers%20notes/brine evaporation/pdf
The content available at: http://www.saltinstitute.org/10/html

Of this list, the most pertinent references located in the search are U.S. Pat. Nos. 6,890,509; 6,776,972; 6,500,216; and 4,334,886.

The Vohra et al. '509 and '972 patents disclose processes for recovery of salt in which the sea water or brine is evaporated to a predetermined density, followed by evaporation in solar pans. Vohra et al. '509 adds calcium chloride to make low sodium salt. Vohra et al '972 treats brine with calcium sulphate and barium chloride, washes the salt with water or dilutes the brine to remove adhering chlorides. The emphasis in these patents is on the sequential recovery of various salts, including table salt.

The Takayasu '216 patent discloses a process for preparing natural sea salt by atomizing sea water and circulating warm air through the sea water and a net or cloth to capture the natural sea salt in the net or cloth. The Tani et al. '886 patent discloses a process for producing sea salt using an evaporation tower. Additional salt is mixed with the brine. Other than these last two patents, we were somewhat surprised by the minimal discussion in the prior art we reviewed of producing sea salt with its trace minerals intact.

None of the above references teaches or suggests a 4 phase process for producing sea salt while maintaining the trace minerals in the salt. We did not find any references discussing specific placement of temperature sensors. We were also unable to find any references that compared our method of determining the specific gravity of the solution.

### BRIEF SUMMARY OF THE INVENTION

This four stage process evaporates filtered sea water to create natural salt crystals of varying shapes and sizes, while maintaining the trace minerals found naturally in sea water. (1) Sea water is pumped directly from its source through a 10 micron filter and into storage tanks that supply an automated brine evaporator; (2) The sea water is evaporated until the brine reaches a predetermined set specific gravity; Once the specific gravity is attained, a valve opens and (3) the brine is piped to a crystalization table in an environmentally controlled separate room where the salt crystals form, grow, and are gathered; and (4) The salt is placed in the dehumidifying room for drying until the desired moisture level is reached. The sea salt is then packaged and stored until sold. This process can be utilized on a year round basis.

### BRIEF DESCRIPTION OF THE SEVERAL VIEWS OF THE DRAWING

FIG. 1 Flow chart of the Invention Process

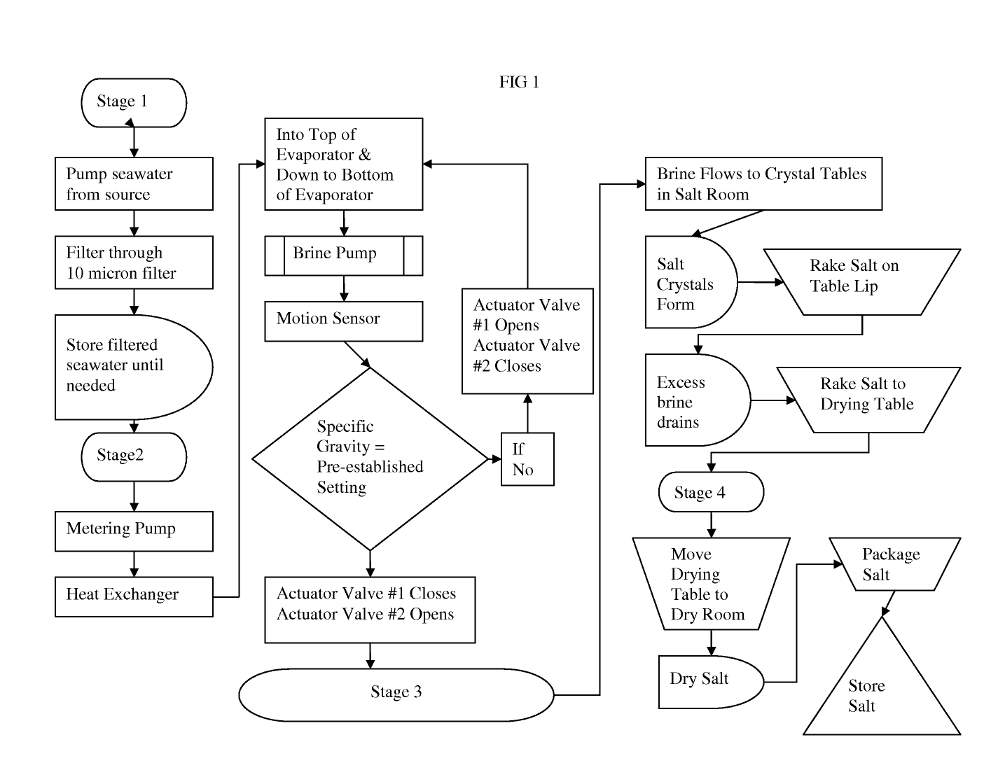

FIG. 2 Flow chart of the Master Control Panel Settings

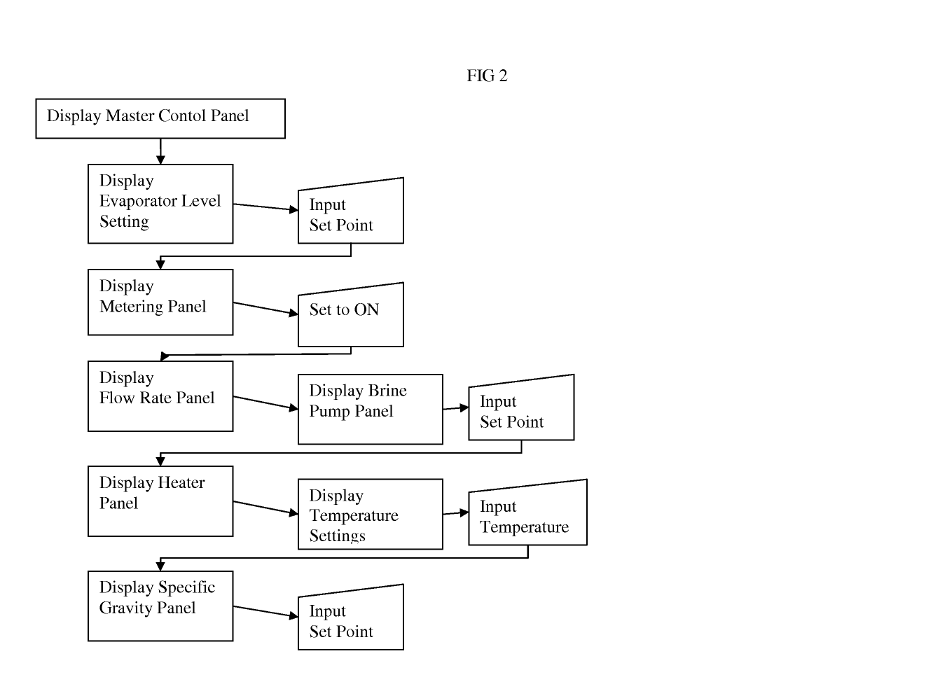

### DETAILED DESCRIPTION OF THE INVENTION

Stage 1: Acquisition of the sea water
(a) A sea water pump, activated either manually or by pre-programming for automatic pumping from the master control panel, pumps sea water from its source into polyvinyl chloride piping;
(b) then through a 10 micron filter, a size filter that allows naturally occurring trace minerals needed for premium all natural sea salt to proceed into the system yet deters other solid particles;
(c) then, into a large capacity plastic storage tank, where it is stored until needed for Stage 2; sea water level switches can be positioned in the tank(s) to ensure a ready supply of filtered sea water provided the sea water pump is set up for automatic filling.

Stage 2: Brine preparation to established specific gravity by the evaporator
(a) A metering pump (connected to the storage tank(s) and monitored by a radar unit that sits atop the evaporator, and which measures the height of the brine level inside the evaporator) with a Variable Frequency Drive, sends the filtered sea water from the storage tank(s) to the brine evaporator at the predetermined level set point established by the control panel operator;
(b) the filtered sea water passes through a gravity fed steam heat exchanger to preheat the sea water prior to entry into the titanium evaporator;
(c) once inside the evaporator, the sea water (desired level is set at the master control panel) is heated by titanium coils filled with food grade oil capable of temperatures up to 550 degrees Fahrenheit, whose temperature is set at the control panel using information sent by temperature probes on both the bottom and also the top of the evaporator until a desired set point is reached and then maintained, supplied by heated thermal fluid held in its own storage tank, forced through those coils by its own pump located on a thermal fluid heater;
(d) the brine is pumped from the bottom of the evaporator to the top of the evaporator in a continuous motion;
(e) through a motion sensor that measures the specific gravity;
(f) and sends a message back to the control panel;
(g) when the specific gravity reaches a set point, the motion detector tells actuator valve #1 to close, then actuator valve #2 to open,
(h) and the brine pump will allow brine to go to the brine tables located in another room until the motion detector reads a specific gravity below the established set point when it will then close actuator valve #2, reopen actuator valve #1, and the brine pump will once again begin pumping the brine from the bottom of the tank to the top of the tank; after closing the valves that flood the tables, the radar system located on top of the evaporator will signal the control panel to balance the level of brine inside the evaporator by having the metering pump send more sea water from the storage tanks.

Stage 3: Premium quality all natural sea salt formation, growth, and harvesting
(a) The room containing the brine table is climate controlled by use of air conditioners and dehumidifiers with a room temperature maintained below 70 degrees Fahrenheit and relative humidity maintained below 60% in order to produce large, quick volumes of sea salt; the brine flows onto the gently warmed (by heat blankets attached to the bottom) titanium or fiberglass (to withstand corrosion) table and crystals begin to form; temperature controls inserted into the brine tell the thermal blankets when heat is needed;
(b) after an adequate number of crystals have formed, they are raked to the back of the tables and onto an upper lip
(c) where excess brine is allowed to run back onto the table;
(d) the remaining salt is raked onto a rolling salt table and leveled out evenly.

Stage 4: The Drying Process
(a) The salt tables are then rolled into a separate dry room maintained above 80 degrees Fahrenheit and with humidity kept below 50%;
(b) the sea salt may take up to three days to dry properly but under these conditions no trace minerals are lost;
(c) the sea salt is packaged;
(d) and the sea salt is stored until sold.

What is claimed is:

1. A four stage environmentally controlled process to obtain food quality all natural sea salt crystals of various size and/or shape without losing the trace minerals naturally present in the sea water using pre-determined set points of maximum temperature for the energy source, the temperature of the brine within the evaporator, and the required specific gravity of the brine just prior to brine release to the crystallization tables that have been established by the operator at the master control panel comprising the steps of:
(a) A sea water pump, activated either manually or by pre-programming for automatic pumping from the master control panel, pumps sea water from its source into polyvinyl chloride piping;
(b) then through a 10 micron filter, a size filter that allows naturally occurring trace minerals needed for premium all natural sea salt to proceed into the system yet deters other solid particles;
(c) then into a large capacity plastic storage tank, where it is stored until needed for Stage 2; sea water level switches can be positioned in the tank(s) to ensure a ready supply of filtered sea water provided the sea water pump is set up for automatic filling;
(d) a metering pump (connected to both the storage tank(s) and monitored by a radar unit that sits atop the evaporator, and which measures the height of the brine level inside the evaporator) with a Variable Frequency Drive, sends the filtered sea water from the storage tank(s) to the brine evaporator at the predetermined level set point established by the control panel operator;
(e) the filtered sea water passes through a gravity fed steam heat exchanger to preheat the sea water prior to entry into the titanium evaporator;
(f) once inside the evaporator, the sea water is heated by titanium coils filled with food grade oil capable of temperatures up to 550 degrees Fahrenheit, whose temperature is set at the control panel using information sent by temperature probes on both the bottom and also the top of the evaporator until a desired set point is reached and then maintained, supplied by heated thermal fluid held in its own storage tank, forced through those coils by its own pump located on a thermal fluid heater; the desired brine level within the evaporator is also set at the control panel;
(g) the brine is pumped from the bottom of the evaporator to the top of the evaporator in a continuous motion
(h) through a motion sensor that measures the specific gravity;
(i) and sends a message back to the control panel;
(j) when the specific gravity reaches a set point, the motion detector tells actuator valve #1 to close, then actuator valve #2 to open,
(k) and the brine pump will allow brine to go to the brine tables located in another room until the motion detector reads a specific gravity below the established set point when it will then close actuator valve #2, reopen actuator valve #1, and the brine pump will once again begin pumping the brine from the bottom of the tank to the top of the tank; after closing the valves that flood the tables, the radar system located on top of the evaporator will signal the control panel to balance the level of brine inside the evaporator by having the metering pump send more sea water from the storage tanks;
(l) the room containing the brine table is climate controlled by use of air conditioners and dehumidifiers with a room temperature maintained below 70 degrees Fahrenheit and relative humidity maintained below 60% in order to produce large, quick volumes of sea salt; the brine flows onto the gently warmed (by heat blankets attached to the bottom) titanium or fiberglass (to withstand corrosion) table and crystals begin to form; temperature controls inserted into the brine tell the thermal blankets when heat is needed;
(m) after an adequate number of crystals have formed, they are raked to the back of the tables and onto an upper lip;
(n) where excess brine is allowed to run back onto the table;
(o) the remaining salt is raked onto a rolling salt table and leveled out evenly;
(p) the salt tables are then rolled into a separate dry room maintained above 80 degrees Fahrenheit and with humidity kept below 50%;
(q) the sea salt may take up to three days to dry properly but under these conditions no trace minerals are lost;
(r) the sea salt is packaged;
(s) and the sea salt is stored until sold.
